(19) United States
(12) Patent Application Publication
(10) Pub. No.: US 2019/0074509 A1
(43) Pub. Date: Mar. 7, 2019

(54) ELECTRODE FOR ELECTROCHEMICAL DEVICE, ELECTROCHEMICAL DEVICE, AND METHOD OF MANUFACTURING THE ELECTRODE AND ELECTROCHEMICAL DEVICE

(71) Applicant: NEC ENERGY DEVICES, LTD., Sagamihara-shi, Kanagawa (JP)

(72) Inventors: Masanori HIRAI, Sagamihara-shi (JP); Kenji SATO, Sagamihara-shi (JP)

(73) Assignee: NEC ENERGY DEVICES, LTD., Sagamihara-shi, Kanagawa (JP)

(21) Appl. No.: 16/083,783

(22) PCT Filed: Dec. 26, 2016
(86) PCT No.: PCT/JP2016/088710

§ 371 Date: Sep. 10, 2018

(30) Foreign Application Priority Data
Mar. 11, 2016 (JP) 2016-048644

(51) Int. Cl. H01M 4/36; H01G 11/28; H01G 11/78; H01G 11/86; H01M 10/0585; H01M 10/04; H01M 4/139

(52) U.S. Cl. CPC H01M 4/366; H01G 11/28; H01G 11/78; H01G 11/60; H01M 10/0585; H01M 10/049; H01M 4/139; H01G 11/86

(57) ABSTRACT

In electrode (2) for an electrochemical device comprising current collector (9) and active material layer (10) made up from active material coated on current collector (9), active material layer (10) comprises lower active material layer (10a) which adheres to current collector (9) and upper active material layer (10b) formed on lower active material layer (10a). Lower active material layer (10a) is thinner than upper active material layer (10b). The termination portion of upper active material layer (10b) in the longitudinal direction of current collector (9) either coincides with the termination portion of lower active material layer (10a) or is positioned nearer side from the starting portion than the termination portion of lower active material layer (10a).

### TECHNICAL FIELD

The present invention relates to an electrode for an electrochemical device, an electrochemical device, and a method of manufacturing the electrode and the electrochemical device.

### BACKGROUND ART

Secondary batteries, a one typical type of electrochemical devices, are widely used as electric power sources of, cellular phones, digital still cameras, laptop computers, electric vehicles and home energy storage systems. Electrochemical devices can be broadly divided between the wound type and the laminated type. A wound-type electrochemical device has a wound configuration in which a pair of long positive electrode sheet and negative electrode sheet are in a state with one stacked on the other with a separator interposed therebetween. A laminated-type electrochemical device, in contrast, has a construction in which a plurality of pairs of electrode sheets, i.e., a plurality of positive electrode sheets and a plurality of negative electrode sheets are alternately laminated one on another with separators interposed therebetween. In contrast to a wound-type electrochemical device that requires one long positive electrode sheet and one long negative electrode sheet, a laminated electrochemical device requires a multiplicity of small positive electrode sheets and a multiplicity of small negative electrode sheets.

The electrode sheets for an electrochemical device are comprised of coated portions which are coated with an active material on a current collector and non-coated portions where the active material is not coated to connect an electrode terminal. A typical method of manufacturing electrodes comprises a step of forming active material layers by intermittently ejecting slurry from a die head to a current collector in the form of a long sheet by moving the current collector with respect to the die head. After the above-described electrodes manufacturing step, individual electrodes are obtained by cutting the current collector on which the active material layers have been formed. Size of the peripheral portions of the active material layer manufactured by an intermittent coating process is larger than one made by a continuous coating process, therefore, a variety of schemes are implemented. As one of these schemes, one known technique involves forming electrodes in multiple layers.

Patent Document 1 discloses a secondary battery in which electrodes have an active material layer of two-layer construction. In addition, Patent Document 2 discloses the use of a plurality of die heads. The invention described in Patent Document 2 is not directed to manufacturing electrodes in which an active material layer is formed on a current collector.

### PRIOR ART DOCUMENTS

### Patent Documents

Patent Document 1: WO2015/087657
Patent Document 2: Japanese Unexamined Patent Application Publication No. 2000-185254

### SUMMARY OF THE INVENTION

### Problem to be Solved by the Invention

In an intermittent coating process, the formation of the active material layer does not end immediately upon halting the ejection of active material slurry from the die head, but rather, the formation of the active material layer continues after the ejection. In other words, even after the die head stops ejecting active material, active material remaining in and around the vicinity of an ejection port of the die head is pulled out with the movement of the current collector and adheres to the current collector. As a result, an active material layer is formed longer than the designed length. Accordingly, excess active material layer formed after the halt of the ejection is cut off from the completed electrode and discarded. Then, the number of discarded electrodes increases, and it results in a large increase of wasted material i.e. increase in manufacturing costs.

In the electrodes that are described in Patent Document 1, tape type insulating members is pasted on the boundary between the coated portions and non-coated portions. This configuration realizes to prevent short circuits of positive electrodes and negative electrodes. And the electrodes are constructed with a two-layer structure to prevent partial thickness increases by these insulating members. However, even in this configuration, no consideration is given to preventing or reducing the drawing out of active material even after the ejection is halted and the consequent formation of an active material layer larger than necessary along the longitudinal direction of the current collector. As a result, the possibility remains that discarded portions will increase and thus cause manufacturing costs to rise. Patent Document 2 discloses the application of coating liquid of different compositions in many layers in the same step but does not take into consideration the suppression of the drawing out of active material after halting ejection.

As a result, it is a purpose of the present invention to provide an electrode for an electrochemical device, and a method of manufacturing the electrode for electrochemical device that prevent or reduce the formation of an active material layer larger than necessary on a current collector and that achieve a reduction of manufacturing costs by decreasing discarded portions.

### Means for Solving the Problem

In an electrode for an electrochemical device of the present invention that comprises a current collector and an active material layer composed of active material coated on the current collector, the active material layer comprises a lower active material layer that adheres to the current collector and an upper active material layer formed on the lower active material layer. The thickness of the lower active material layer is less than the thickness of the upper active material layer. The termination portion of the upper active material layer in the longitudinal direction of the current collector either coincides with the termination portion of the lower active material layer or is positioned nearer side from the starting portion than the termination portion of the lower active material layer.

A method of manufacturing an electrode for an electrochemical device of the present invention comprising a current collector and an active material layer comprising:

forming a lower active material layer on the current collector;

forming an upper active material layer that overlies the lower active material layer; and

cutting the current collector on which the lower active material layer and the upper active material layer has been formed;

The lower active material layer is thinner than the upper active material layer. In forming the upper active material layer, the upper active material layer is formed such that the termination portion of the upper active material layer in the longitudinal direction of the current collector either coincides with the termination portion of the lower active material layer or is positioned nearer side from the starting portion than the termination portion of the lower active material layer.

### Effect of the Invention

The present invention prevents or reduces the formation of an active material layer larger than necessary on a current collector and achieves a reduction of manufacturing costs by decreasing discarded portions.

### BRIEF DESCRIPTION OF THE DRAWINGS

FIG. 1a is a top view showing a secondary battery that is an example of the electrochemical device of the present invention.

FIG. 1b is a cross-sectional view taken along line A-A of FIG. 1a.

FIG. 2 is an enlarged view of the principal parts of a positive electrode of the secondary battery shown in FIGS. 1a and 1b.

FIG. 3 is an enlarged view showing the principal parts of a negative electrode of the secondary battery shown in FIGS. 1a and 1b.

FIG. 4 is a schematic view showing the coating device that is used in the method of manufacturing electrodes for an electrochemical device of the present invention.

FIG. 5a is an enlarged view showing the formation process of a lower active material layer of the positive electrode shown in FIG. 2.

FIG. 5b is an enlarged view showing the formation process of an upper active material layer of the positive electrode shown in FIG. 2.

FIG. 6 is an enlarged view showing the formation process of an active material layer of a positive electrode of a comparative example.

FIG. 7 is a top view showing the cutting process for manufacturing positive electrodes of the comparative example shown in FIG. 6.

FIG. 8 is a top view showing the cutting process for manufacturing the positive electrode shown in FIG. 2.

FIG. 9 is a top view showing the cutting process for manufacturing positive electrodes according to another exemplary embodiment of the present invention.

### EXEMPLARY EMBODIMENTS OF THE INVENTION

Exemplary embodiments of the present invention are described with reference to the accompanying drawings.

### Configuration of Secondary Battery

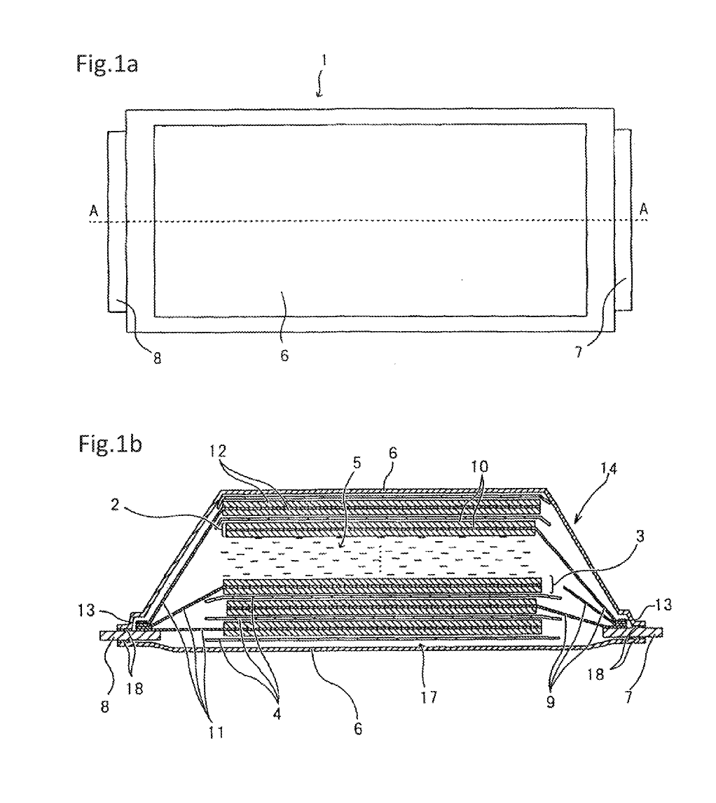

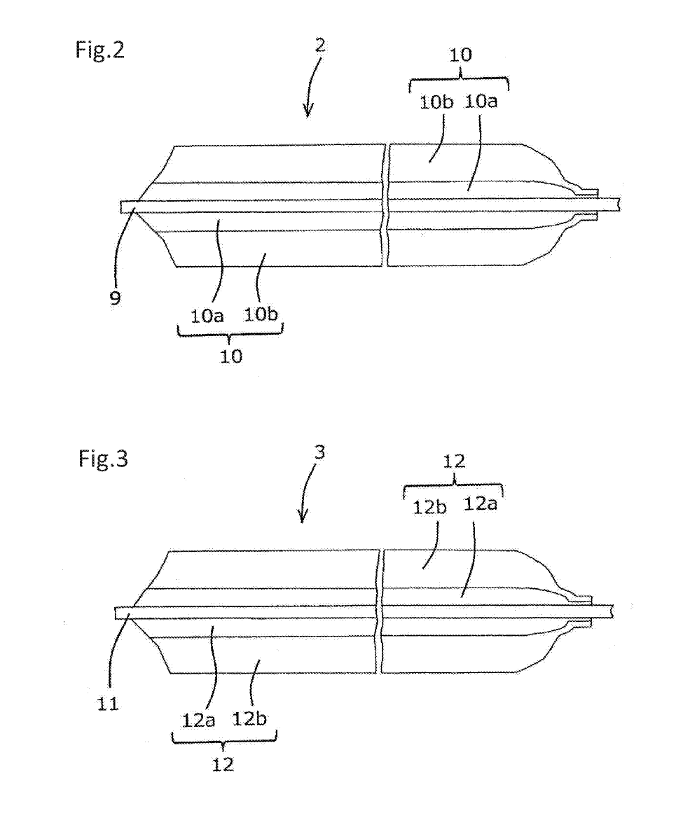

FIGS. 1a and 1b give schematic representations of secondary battery 1 that is an example of the electrochemical device of the present invention. FIG. 1a is a top view as seen from perpendicularly above the principal surface of secondary battery 1, and FIG. 1b is a cross-sectional view taken along line A-A of FIG. 1a. FIG. 2 is an enlarged view of positive electrode 2, and FIG. 3 is an enlarged view of negative electrode 3.

Secondary battery 1 of the present invention is provided with multilayered electrode body 17 in which electrodes of two types, i.e., positive electrodes and negative electrodes 3 are alternately laminated on each other with separators interposed therebetween. This multilayered electrode body 17 is accommodated together with electrolyte 5 in the interior of outer case 14 that is made up from flexible film 6. One end portion of positive electrode terminal 7 is connected to positive electrodes 2 of multilayered electrode body 17 and one end portion of negative electrode terminal 8 is connected to negative electrodes 3. The other end portion of positive electrode terminal 7 and the other end portion of negative electrode terminal 8 are drawn out to the exterior of outer case 17 that is made up from flexible film 6. In FIG. 1b, the layers positioned in the central portion in the direction of thickness are omitted from the figure and electrolyte 5 is shown. Although positive electrodes 2, negative electrodes 3, separators 4, and flexible film 6 are shown as not being in contact with each other in FIG. 1b in the interest of clarity these components are laminated in close contact with each other.

Either or both of positive electrodes 2 or negative electrodes 3 comprise two or more layers of active material layers.

Each of positive electrodes 2 comprises positive electrode current collector 9, and positive electrode active material layer 10 coated on positive electrode current collector 9. There are coated portions in which positive electrode active material layer 10 is formed and non-coated portions in which positive electrode active material layer 10 is not formed on the obverse surface and reverse surface of positive electrode current collector 9. Although not shown in detail in FIGS. 1a and 1b, when positive electrode active material layer 10 is made up by two layers, lower active material layer 10a and upper active material layer 10b are stacked and configurates a two-layer construction as shown in FIG. 2, wherein the thickness of lower active material layer 10a is less than that of upper active material layer 10b, and preferably equal to or less than 20 μm. Similarly, negative electrodes 3 each comprise negative electrode current collector 11 and a negative electrode active material layer 12 coated on negative electrode current collector 11. There are coated portions and non-coated portions on the obverse surface and reverse surface of negative electrode current collectors 11. When negative electrode active material layer 12 is made up by two layers, lower active material layer 12a and upper active material layer 12b are stacked and configurates a two-layer construction, wherein the thickness of lower active material layer 12a is less than that of upper active material layer 12b, and preferably no more than 20 μm.

Each of the non-coated portions 9 and 11 is respectively used as positive electrode tab and negative electrode tab for connecting with positive electrode terminal 7 and negative electrode terminal 8. In the case of FIG. 1b, non-coated portions of positive electrode current collectors 9 are gathered together on one end portion of positive terminal 7 to form a collection part, and this collection part is interposed between metal tab 13 and positive terminal 7, and these parts are connected by, for example, ultrasonic welding at the point at which these parts overlap each other. Similarly, non-coated portions of negative electrode current collector 11 are gathered together on one end portion of negative electrode terminal 8 to form a collection part, this collection part is interposed between metal tab 13 and negative electrode terminal 8, and these parts are connected by, for example, ultrasonic welding at the point at which these parts overlap each other. The other end portion of positive electrode terminal 7 and the other end portion of negative electrode terminal 8 each extend to the exterior of outer case 14 that is made up from flexible film 6.

The outer dimensions of the negative electrode active material layers 12 are preferably longer than positive electrode active material layers 10 and preferably equal to or smaller than the outer dimensions of separators 4.

In film-sheathed secondary battery 1, multilayered electrode body 17 is covered by flexible film 6 from both sides of the principal surface and overlapping flexible film 6 is bonded together and sealed at the outer sides of the outer peripheries of multilayered electrode body 17. In this way, outer case 14 that accommodates multilayered electrode body 17 and electrolyte 5 is formed. Typically, flexible film 6 is a laminated film in which resin layers are provided on both sides of metal foil that is a substrate, at least the resin layer on the inner side being made up from thermally fusible resin such as modified polyolefin. The resin layers of the inner sides that are composed of thermally fusible resin are then heated in a state of being in direct contact with each other and are thus fused together to realize heat welding and form outer case 14 in which the outer circumference is sealed.

Materials that can be considered as the active material that makes up positive electrode active material layers 10 in the secondary battery of the present exemplary embodiment comprise, for example, a layered oxide-based material such as LiCoO₂, LiNiO₂, LiMn₂O₂, Li₂MO₃—LiMO₂, or LiNi_{1/3}Co_{1/3}Mn_{1/3}O₂; a spinel-based material such as LiMn₂O₄; an olivine-based material such as LiMPO₄; an olivine-fluoride-based material such as Li₂MPO₄F or Li₂MSiO₄F; and a vanadium-oxide-based material such as V₂O₅. In each of the positive electrode active materials, a portion of the elements that make up these active materials may be replaced by another element, or Li may be an excess component. Alternatively, a mixture of one, two, or more types among these active materials can be used.

Materials that can be used as the active material that makes up negative electrode active material layers 12 comprise carbon materials such as graphite, amorphous carbon, diamond-like carbon, fullerene, carbon nanotube, and carbon nanohorn; a lithium metal material; an alloy material such as silicon or tin; an oxide-based material such as Nb₂O₅ or TiO₂; or a composite of any of these materials.

The active material mixture that makes up positive electrode active material layers 10 and negative electrode active material layers 12 is a substance in which a binding agent or conductive auxiliary agent has been added as appropriate to each of the previously described active materials. One or a combination of two or more of carbon black, carbon fibers, and graphite can be used as the conductive assistant. In addition, polyvinylidene fluoride, polytetrafluoroethylene, carboxymethyl cellulose, styrene-butadiene rubber, and modified acrylonitrile rubber particles can be used as the binding agent.

In either of positive electrode active material layers 10 and negative electrode active material layers 12, the unavoidable inclination, unevenness, or curvature in each layer that arise due to layer formation capabilities or variations in manufacturing processes present no problem.

Aluminum, stainless steel, nickel, titanium, or an alloy of these metal can be used as positive electrode current collectors 9, but aluminum is preferable. Copper, stainless steel, nickel, titanium, or an alloy of these metals can be used as negative electrode current collectors 11.

As electrolyte 5, one or a mixture of two or more can be used from among organic solvents such as cyclic carbonates such as ethylene carbonate, propylene carbonate, vinylene carbonate, and butylene carbonate; chain carbonates such as ethyl methyl carbonate (EMC), diethyl carbonate (DEC), dimethyl carbonate (DMC), and dipropyl carbonate (DPC); aliphatic carboxylic acid esters; γ-lactones such as γ-butyrolactone; chain ethers; and cyclic ethers. Further, lithium salt can also be dissolved in these organic solvents.

Separators 4 are chiefly composed of porous film, woven fabric, or nonwoven fabric made of resin, and materials that can be used as the resin component comprise, for example, polyolefin resins such as polypropylene and polyethylene, polyester resins, acryl resins, styrene resins, nylon resins, aromatic polyamide resins, and polyimide resins. A polyolefin-based microporous film is particularly preferable due to its excellent ion permeability and its capacity to physically isolate positive electrodes and negative electrodes. In addition, a layer that comprises inorganic particles may also be formed on separators 4. Materials that can be considered as the inorganic particles comprise insulative oxides, nitrides, sulfides, and carbides, and of these, materials that contain TiO₂ or Al₂O₃ are preferable.

Outer case 14 is a lightweight outer case composed of flexible film 6, and flexible film 6 is a laminated film provided with a metal foil that is a substrate and with resin layers on both sides of the metal foil. As the metal foil, a material can be selected that has a barrier capability to prevent leakage of electrolyte 5 or the influx of moisture from the outside, and materials such as aluminum and stainless steel can be used.

A thermally fusible resin layer such as modified polyolefin is provided on at least one surface of the metal foil. The thermally fusible resin layers of flexible film 6 are arranged opposite each other, and outer case 14 is formed by thermally fusing the periphery of the portion that accommodates multilayered electrode body 17. A resin layer such as nylon film, polyethylene terephthalate film, or polyester film can be provided as the obverse surface of outer case 14 on the surface opposite the surface on which the thermally fusible resin layer 6b is formed.

A material constituted by aluminum or an aluminum alloy can be used as positive electrode terminal 7. Materials that can be used as negative electrode terminal 8 comprise copper, copper alloy, a material in which copper or copper alloy has been subjected to nickel plating, and nickel. The end portions of the other sides of these terminals 7 and 8 are led out to the outside of outer case 14. Sealant 18 can be provided in advance on the sites of each of terminals 7 and 8 that correspond to the portions of the outer periphery of outer case 14 that are to be thermally fused.

Metal tabs 13 prevent damage to positive electrode current collector 9 or negative electrode current collector 11 and improve the reliability of connections between the electrode tabs and positive electrode terminal 7 or negative electrode terminal 8. Metal tabs 13 preferably are thin and strong and are provided with resistance to electrolyte 5. Preferable materials that can be considered for forming support tabs 13 include aluminum, nickel, copper, and stainless steel.

### Method of Manufacturing Secondary Battery

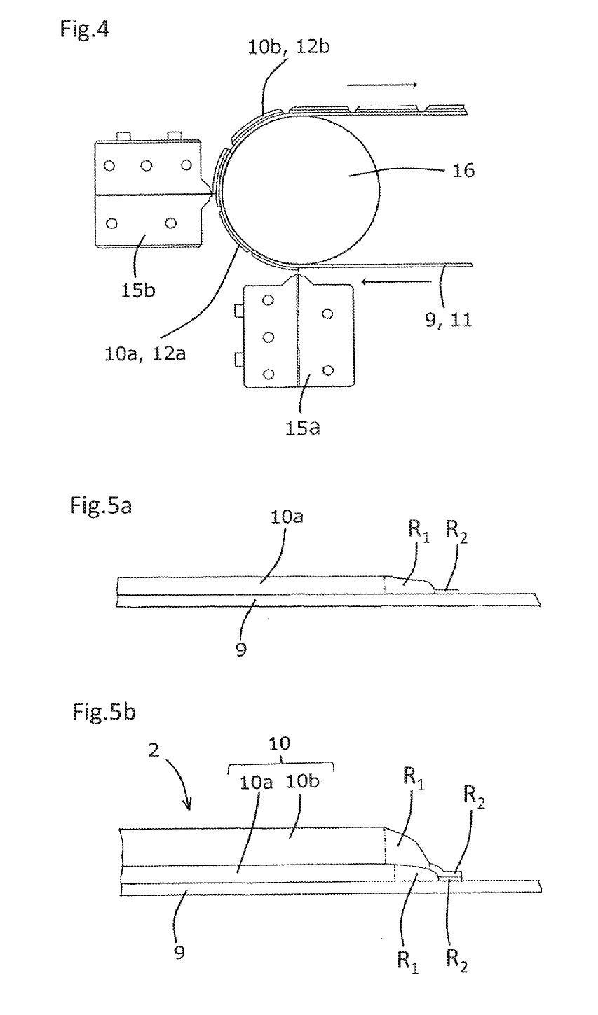

FIG. 4 is a schematic view showing the coating device used in the method of manufacturing electrodes for the electrochemical device of the present invention, and more specifically, gives a schematic representation of the coating portion of a die coater.

In the manufacture of secondary battery 1, as shown in FIG. 4, a die coater that comprises two die heads 15a and 15b and a conveyor device 16 for conveying a current collector 9 or 11 to pass positions that face the two die heads 15a and 15b are used to manufacture electrodes 2 and 3 shown in FIGS. 2 and 3.

In FIG. 4, each of die heads 15a and 15b is arranged to face their ejection ports toward cylindrical back roll 16, and positive electrode current collector 9 or negative electrode current collector 11 is arranged between die heads 15a, 15b and back roll 16. The active material is coated when the current collector is conveyed in one direction, whereby the active material layer can be formed on the current collector in along the longitudinal direction. Die heads 15a and 15b is not necessarily arranged at points where back roll 16 is present. Die heads 15a and 15b may also be arranged and may perform coating at floating points in spaces between the conveyance rollers (not shown in the figure).

Next explanation is presented taking positive electrode 2 as an example.

FIG. 5a is a schematic view of the state in which lower active material layer 10a of positive electrode 2 has been formed and shows an enlarged view of the application-ending portion of the coating. FIG. 5b is a schematic view of the state in which upper active material layer 10b has been formed on lower active material layer 10a and shows an enlarged view of the application-ending portion of the coating.

As shown in FIG. 4, while conveying positive electrode current collector 9, positive electrode active material is applied from die head 15a positioned on the upstream side in the direction of conveyance to form lower active material layer 10a (see FIG. 5a). Then, positive electrode active material is applied from die head 15b positioned on the downstream side to form upper active material layer 10b on lower active material layer 10a. In this way, two-layer structure of positive electrode active material layer 10 is formed (see FIG. 5b). Upper active material layer 10b is formed by ejecting slurry containing active material from the two die heads 15a and 15b shown in FIGS. 5a and 5b onto positive electrode current collector 9 that is being conveyed to continuously, while lower active material layer 10a is wet or half-dried state in which a portion of solvent has evaporated. Lower active material layer 10a is preferably a thinner than upper active material layer 10b in the interest of increasing productivity. Then, explanation regards the technical significance of two-layer structure of positive electrode active material layer 10.

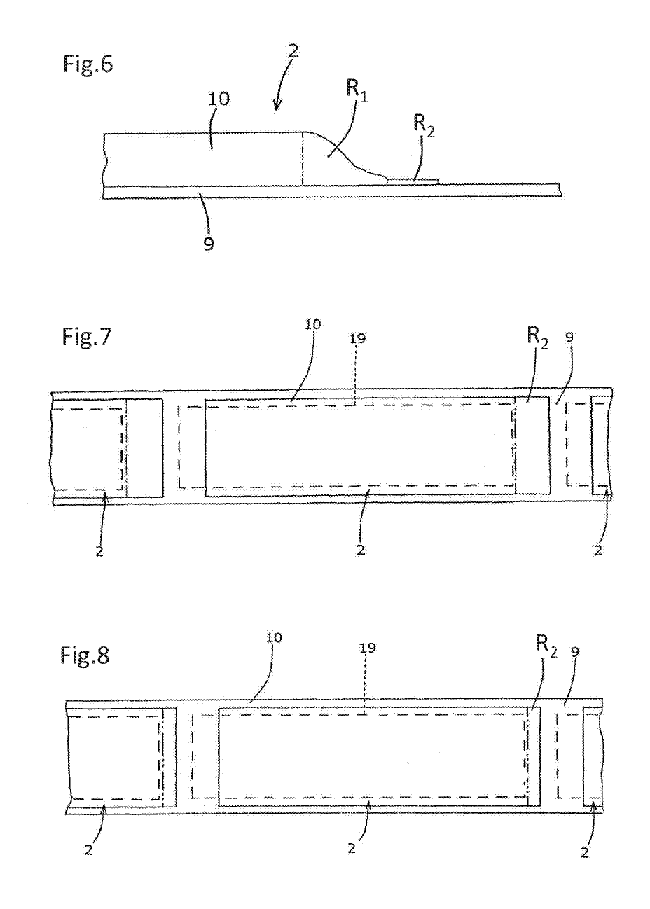

When active material is applied from a die head to form active material layer 10 on current collector 9, the supply of active material into the die head is halted when active material layer 10 of a predetermined length has been formed, but the ejection of active material from the die head does not immediately stop at that time. After the supply of active material into a die head is halted, the amount of ejection gradually decreases until the ejection finally stops. The thickness of active material layer 10 formed on current collector 9 gradually decreases in accordance with this decrease of the ejection amount (layer thickness decrease portion R₁ shown in FIG. 6). Although the formation of active material layer 10 is expected to end at the same time when the ejection stops, the formation of active material layer 10 continues after the time when ejection is halted, in fact. It is the reason that the remaining active material on and near the ejection port of the die head is pulled out to the current collector side along with the movement of the current collector and adheres to the current collector after the time when ejection is halted. The portion in which an active material layer has been formed in this way after the halt of ejection is shown as pulled-out portion R₂ in FIG. 6. The above-described layer thickness decrease portion R₁ and pulled-out portion R₂ form otiosely longer portion of active material layer 10. The surplus portion of this active material layer 10 is cut off, and discarded as an unnecessary portion. Positive electrodes 2 are individually formed by cutting current collector 9 on which active material layer 10 has been formed along cutting lines 19 as shown in FIG. 7 (cutting lines 19 are imaginary lines and are not actually formed). Pulled-out portion R₂ of active material layer 10 makes an otiose length of active material layer 10 than required, and it also cannot be used as electrode tab because of the presence of active material. So, this pulled-out portion R₂ is weeded out. As shown in FIG. 7, discarded pulled-out portion R₂ causes increases of manufacturing costs. In addition, the number of electrodes 2 manufactured from current collectors 9 decreases and it makes the production efficiency worse. These pulled-out portions R₂ are produced at the termination portions of active material layer 10, i.e., the end portions on the side at which the application of active material terminates. The pulled-out portions are not produced at the starting portions of active material layer 10, i.e., the end portions on the sides at which the application of active material begins as shown on the left sides of FIGS. 2 and 3. In the longitudinal direction, the starting portions of lower active material layer 10a and the starting portions of upper active material layer 10b are substantially coincide with each other. The starting portions of the active material layers start up relatively abruptly without the occurrence of wasted space.

As the result of investigation by the inventors of the present application, it was determined that the length of pulled-out portion R₂ of a termination portion becomes more conspicuous in accordance with increasing thickness of active material layer 10. For example, as shown in FIGS. 6 and 7, in case approximately 120 μm thickness active material layer 10 is formed, approximately 5 mm length pulled-out portion R₂ is formed after halting the ejection. In contrast, the length of pulled-out portion R₂ decreases if the thickness of active material layer 10 is reduced. For example, in case approximately 20 μm active material layer 10 is formed, the length of pulled-out portion R₂ is approximately 1 mm.

In the present exemplary embodiment, active material layer 10 formed on current collector 9 is made a two-layer construction and the thickness of lower active material layer 10a is made less than the thickness of upper active material layer 10b. In case formed lower active material layer 10a is not thick than 20 μm, the length of pulled-out portion R₂ becomes approximately 1 mm, as described above. Adequate thickness of active material layer 10 that is to be formed on current collector 9 cannot be put into practice by only forming lower active material layer 10a, and therefore, upper active material layer 10b is formed on lower active material layer 10a to form active material layer 10 whose thickness is within designed range. More specifically, in case positive electrode active material layer 10 of positive electrode 2 is to be designed of which thickness is approximately 120 μm, the thickness of lower active material layer 10a is designed 20 μm or less and the thickness of upper active material layer 10b is designed 100 μm or more. By means of this configuration, the pulled-out portion R₂ of lower active material layer 10a is controlled to approximately 1 mm. On the other hand, upper active material layer 10b is relatively thick, and as a result, the length of pulled-out portion R₂ formed after halting the ejection from die head 15b may possibly be 3-4 mm when the active material is applied directly to the current collector foil. However, by forming upper active material layer 10b on the lower active material layer, upper active material layer 10b can be formed on lower active material layer 10a without protruding from the outer side of lower active material layer 10a when viewed planarly.

When positive electrodes 2 are individually obtained by cutting along cutting lines 19 shown in FIG. 8, the amount of positive electrode active material layer 10 discarded as an unnecessary portion is small and manufacturing costs are reduced to a low level. In other words, a portion of pulled-out portion R₂ of upper active material layer 10b having a length of 3-4 mm overlies layer thickness decrease portion R₁ of lower active material layer 10a and falls within the range of the designed length of positive electrode active material layer 10. Moreover, the thickness of positive electrode active material layer 10 in this portion is the total of the thickness of pulled-out portions R₂ of upper active material layer 10b and the thickness of layer thickness decrease portion R₁ of lower active material layer 10a, whereby the total thickness of positive electrode active material layer 10 becomes within designed range to function as positive electrode 2. Hence, a portion of pulled-out portion R₂ of upper active material layer 10b is usable as a portion of positive electrode active material layer 10 and need not be removed from the completed electrode. The portion that is preferably removed from the completed electrode is only the pulled-out portion R₂ (having a length on the order of 1 mm) of lower active material layer 10a, whereby current collector 9 and active material are effectively utilized and manufacturing costs controlled to a low level. The thickness of lower active material layer 10a is preferably not more than 20 μm or preferably not more than 200% of the particle diameter (for example, 10-15 μm) of the active material. Still further, the ratio of the thicknesses of lower active material layer 10a and upper active material layer 10b is preferably from 1:5 to 1:7, in other words, the thickness of lower active material layer 10a is preferably from ⅕ to 1/7 the thickness of upper active material layer 10b.

Thus, in the present exemplary embodiment, pulled-out portion R₂ of upper active material layer 10b formed after the ejection from die head 15b is halted is controlled not to protrude from the lower active material layer 10a when viewed planarly. In other words, the termination portion of upper active material layer 10b is designed to either coincide with the termination portion of lower active material layer 10a in the longitudinal direction of current collector 9 or is positioned nearer side from the starting portion than the termination portion of lower active material layer 10a. This configuration is realized by early ejection stopping based on anticipated length of the portion formed after halting the ejection of active material. In other words, the halting of the ejection of active material that forms upper active material layer 10b is carried out at a timing that precedes the timing at which the termination portion of lower active material layer 10a comprising pulled-out portion R₂ reaches the opposite position of die head 15b by a time interval being equal to or greater than the time interval in which pulled-out portion R₂ of upper active material layer 10b is formed (the time interval in which upper active material layer 10b continues to be formed following the termination of the ejection of active material). Alternatively, the halting of the supply of active material into die head 15b is carried out at a timing that precedes the timing at which the termination portion of lower active material layer 10a comprising pulled-out portion R₂ reaches the opposite position of die head 15b by a time interval being equal to or greater than the total of the time interval from halting the supply of active material until the termination of ejection from die head 15b and the time interval in which pulled-out portion R₂ of upper active material layer 10b is formed (the time interval in which upper active material layer 10b continues to be formed following termination of the ejection of active material). When the coating thickness of upper active material layer 10b is assumed to be 100 μm, die head 15b is controlled such that the ejection of active material halts (layer thickness decrease portion R₁ terminates) at a position that precedes the termination portion of lower active material layer 10a by 3 mm. The thickness of each layer described by way of example in the explanation above is the thickness of the completed state, i.e., the thickness of the state in which the active material has dried and solidified, the thickness before the applied active material solidifies being greater than this thickness. For example, when lower active material layer 10a is formed at a thickness of 20 μm, the thickness before the applied active material solidifies is on the order of 35-40 μm. When upper active material layer 10b is formed at a thickness of 100 μm, the thickness before the applied active material solidifies is controlled approximately 150 μm.

The formation of positive electrode active material layer 10 of two-layer construction described above can be carried out on both surfaces or one surface of positive electrode current collector 9 to manufacture positive electrode 2 shown in FIG. 2. In addition, negative electrode 3 can be adopted in which negative electrode active material layers 12 of two-layer construction are formed on both surfaces of negative electrode current collector 11 as shown in FIG. 4 by steps like the previously described steps. As shown in FIGS. 1a and 1b, these positive electrodes 2 and negative electrodes 3 are alternately stacked on each other with separators 4 interposed therebetween and connected to positive electrode terminal 7 and negative electrode terminal 8. More specifically, the positive electrode current collectors 9 of a plurality of positive electrodes 2 are superimposed in close contact on one end portion of positive electrode terminal 7 and a metal tab 13 is further arranged on these parts, whereupon these parts are gathered together and joined. Although there is a plurality of methods of joining the electrode tabs and electrode terminal, joining by ultrasonic welding is usually adopted. In other words, ultrasonic welding can be affected by pressing a horn and anvil (not shown in the figure) against each of positive electrode terminal 7 and metal tab 13 that clasp a plurality of positive electrode current collectors and then applying vibration while applying pressure. In negative electrodes 3 as well, like positive electrodes 2, a collection portion in which a plurality of negative electrode current collectors 11 are superimposed is clasped by support tab 13 and negative electrode terminal 8 and then subjected to ultrasonic welding. In the present exemplary embodiment, pulled-out portions R₂ are controlled in positive electrodes 2 and negative electrodes 3, and portions of current collectors 9 and 11 near the starting portions of active material layers 10 and 12 featuring good space efficiency are used as electrode tabs.

In this way, the multilayered electrode body 17 is manufactured by connecting positive electrode terminal 7 to the non-coated portions of positive electrodes 2, i.e. positive electrode current collectors 9 and, by connecting negative electrode terminal 8 to the non-coated portions of negative electrodes 3 i.e. negative electrode current collectors 11. Then the principal surfaces of the multilayered electrode body 17 is covered from above and below by flexible film 6. Excepting one portion, pressure and heat are then applied to, the portions in which flexible film 6 overlaps at the outer sides of the outer periphery of multilayered electrode body 17 as seen planarly. Then the resin layer 6b on the inner sides of flexible film 6 is thermally fused and joined together. At that time, positive electrode terminal 7 and negative electrode terminal 8 is fixed to the outer periphery of flexible film 6 by way of sealant 18 that has been provided beforehand. On the other hand, of the portions in which flexible film 6 overlaps, the portion to which pressure and heat have not been applied remains as an open portion and used as injection port at the following step. Typically, an injection port is formed in a portion of any one side of the sides of outer case 14 excepting the side in which positive electrode terminal 7 is arranged and the side in which negative electrode terminal 8 is arranged. Electrolyte 5 is then injected into the interior of outer case 14 from the injection port. The sides other than the injection port have already been sealed, and electrolyte 5 therefore does not leak. Further, electrolyte 5 does not infiltrate portions in which flexible film 6 overlaps itself. Pressure and heat is then applied to the injection port and the t resin layer 6b of the inner side of flexible film 6 is thermally fused and joined together.

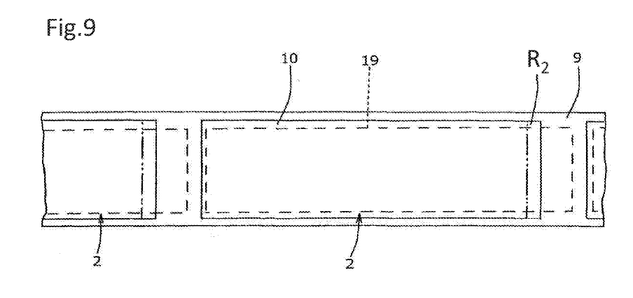

FIG. 9 shows another exemplary embodiment of the electrodes for an electrochemical device of the present invention. In this exemplary embodiment, the current collector of the termination portion sides of the active material are used as the electrode tabs in positive electrodes 2 and negative electrode 3. Because pulled-out portions R₂ of the termination portions are small as previously described, the electrode tabs can be provided on this termination portion side. In this configuration, the sufficiently short pulled-out portions R₂ of lower active material layer 10a are not removed, and the manufacturing efficiency is improved. In addition, when tape type insulating members are arranged to cover the boundary portions of the termination portions of active material layers in this configuration, arranging insulating members on thin pulled-out portions R₂ prevents or reduces thickness increase of the whole multilayered electrode body caused by the thickness of the insulating members, and as a result pulled-out portions R₂ is used effectively.

In a lithium-ion secondary battery that is an example of an electrochemical device, the released lithium ion during charge is occluded in negative electrodes 3, but if the charge capacity C of negative electrodes 3 is too small, the problem may occur that lithium ion cannot be adequately occluded in negative electrodes and lithium metal is precipitated on the surface of negative electrodes 3. Accordingly, it is well known that A/C ratio i.e. the ratio of charge capacity A of negative electrodes to charge capacity C of positive electrodes must be designed more than 1 to prevent precipitation of lithium metal upon the surface of negative electrodes 3. This preferable A/C ratio must be kept in all over the area where a pair of positive electrode and negative electrode face each other not only as a whole but also topically. As a result, the area of negative electrodes must be designed larger than positive electrodes so that any portions of positive electrodes always face the negative electrodes. Accordingly, the existence of large pulled-out portions R₂ on positive electrodes 2 was not preferable. In the present invention, pulled-out portions R₂ of positive electrode active material layers 10 is enough small that the pulling-out portion is felt into the place at which negative electrodes are faced. and the A/C balance is kept as designed. Non-coated portions can thus be used as electrode tabs. In other words, electrode tabs can be formed on the termination portion side of positive electrode active material layers 10, as shown in FIG. 9.

In the exemplary embodiment described above, multilayered electrode body 17 in which a plurality of positive electrodes 2 and a plurality of negative electrodes 3 are alternately stacked on each other with separators interposed therebetween is used as a charging element. However, the present invention can also be applied to a charging element in which only one positive electrode 2 and only one negative electrode 3 are stacked one on the other with separator 4 interposed therebetween. In addition, the present invention is particularly useful in a lithium-ion secondary battery, but the present invention is also effective when applied to secondary batteries other than lithium-ion batteries or electrochemical devices other than batteries such as capacitors or condensers.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

This application claims the benefits of priority based on Japanese Patent Application No. 2016-48644 for which application was submitted on Mar. 11, 2016 and incorporates by citation all the disclosures of Japanese Patent Application No. 2016-48644.

### EXPLANATION OF THE REFERENCE NUMBERS

1 secondary battery
2 positive electrode
3 negative electrode
4 separator
5 electrolyte
6 flexible film
7 positive electrode terminal
8 negative electrode terminal
9 positive electrode current collector
10 positive electrode active material layer
11 negative electrode current collector
12 negative electrode active material layer
13 metal tab
14 outer case
15a, 15b die head
16 roll
17 multilayered electrode body
18 sealant
19 cutting line

1. An electrode for an electrochemical device comprising
a current collector and
an active material layer composed of active material coated on the current collector, wherein:
the active material layer comprises a lower active material layer that adheres to the current collector and
an upper active material layer formed on the lower active material layer;
the thickness of the lower active material layer is less than the thickness of the upper active material layer; and
in the longitudinal direction of the current collector, the termination portion of the upper active material layer either coincides with the termination portion of the lower active material layer or is positioned nearer side from the starting portion than the termination portion of the lower active material layer.

2. The electrode for an electrochemical device according to claim 1, wherein the termination portion of the upper active material layer does not protrude to outside the termination portion of the lower active material layer when viewed planarly.

3. The electrode for an electrochemical device according to claim 1, wherein the thickness of the lower active material layer is 20 μm or less.

4. The electrode for an electrochemical device according to claim 1, wherein the thickness of the lower active material layer is 200% or less of the particle diameter of the active material.

5. The electrode for an electrochemical device according to claim 1, wherein the ratio of the thicknesses of the lower active material layer and the upper active material layer is 1:5-1:7.

6. An electrochemical device comprising:
a multilayered electrode body made up from a positive electrode and a negative electrode made up from the electrode for an electrochemical device according to claim 1 and separator that is arranged between the positive electrode and the negative electrode;
an outer case that accommodates the multilayered electrode body; and
electrolyte accommodated in the interior of the outer case together with the multilayered electrode body.

7. A method of manufacturing an electrode for an electrochemical device comprising
a current collector and an active material layer comprising:
forming a lower active material layer on the current collector;
forming an upper active material layer that overlies the lower active material layer; and
cutting the current collector on which the lower active material layer and the upper active material layer has been formed;
wherein:
the lower active material layer is thinner than the upper active material layer; and in forming the upper active material layer,
the upper active material layer is formed such that termination portion of the upper active material layer in the longitudinal direction of the current collector either coincides with the termination portion of the lower active material layer or is positioned nearer side from the starting portion than the termination portion of the lower active material layer.

8. The method of manufacturing an electrode for an electrochemical device according to claim 7, wherein:
in forming the upper active material layer,
the upper active material layer is formed such that termination portion of the upper active material layer does not protrude to the outer side of termination portion of the lower active material layer when viewed planarly.

9. The method of manufacturing an electrode for an electrochemical device according to claim 7, wherein:
in forming the lower active material layer on the current collector,
active material is ejected from a die head toward the current collector; and
in forming the upper active material layer,
active material is ejected from a downstream side die head positioned on the downstream side in the conveyance direction of the current collector than an upstream side die head used in forming the lower active material layer toward the current collector being conveyed in a state in which the lower active material layer has been formed, and
the active material is formed on the lower active material layer.

10. The method of manufacturing an electrode for an electrochemical device according to claim 7, wherein,
in forming the lower active material layer,
the lower active material layer is formed at a thickness of 20 μm or less.

11. The method of manufacturing an electrode for an electrochemical device according to claim 7, wherein,
in forming the lower active material layer,
the lower active material layer is formed at a thickness that is 200% or less of the particle diameter of the active material.

12. The method of manufacturing an electrode for an electrochemical device according to claim 7, wherein,
in forming the lower active material layer,
the lower active material layer is formed at a thickness of from ⅕ to 1/7 of the thickness of the upper active material layer.

13. The method of manufacturing an electrode for an electrochemical device according to claim 7, wherein,
in forming the upper active material layer,
the ejection of the active material is halted at a timing that is earlier than a timing at which the termination portion of the lower active material layer reaches an opposite position of the die head
by a time, interval being equal to or greater than the time interval in which the upper active material layer continues to be formed following the termination of the ejection of the active material.

14. The method of manufacturing an electrode for an electrochemical device according to claim 13, wherein,
in forming the upper active material layer,
the supply of the active material to the die head is halted at a timing that is earlier than a timing at which the termination portion of the lower active material layer reaches an opposite position of the die head
by a time, interval being equal to or greater than the time interval that is the total of the time interval from the supply halt of the active material until the end of ejection and the time interval during which the upper active material layer continues to be formed following the end of ejection of the active material.

15. A method of manufacturing an electrochemical device comprising:
manufacturing a positive electrode and a negative electrode by the method of manufacturing an electrode for an electrochemical device according to claim 7;
forming a multilayered electrode body by alternately laminating together the positive electrode and the negative electrode with a separator interposed therebetween; and
accommodating the multilayered electrode body together with an electrolyte inside an outer case.
